(19) United States
(12) Patent Application Publication
(10) Pub. No.: US 2004/0177218 A1
(43) Pub. Date: Sep. 9, 2004

(54) Multiple level raid architecture

(76) Inventors: Thomas F. Meehan, Los Altos, CA (US); Raymond A. Bahar, San Jose, CA (US); Garrick Yeung, Cupertino, CA (US); Rajendra Bhadra, San Jose, CA (US)

Correspondence Address: IRELL & MANELLA LLP, 840 NEWPORT CENTER DRIVE, SUITE 400, NEWPORT BEACH, CA, 92660, US

(21) Appl. No.: 10/702,835

(22) Filed: Nov. 5, 2003

Related U.S. Application Data
(60) Provisional application No. 60/424,130, filed on Nov. 6, 2002.
(60) Provisional application No. 60/424,348, filed on Nov. 6, 2002.

(51) Int. Cl. G06F 13/00

(52) U.S. Cl. 711/114

(57) ABSTRACT

A method, apparatus, and system for implementing a multi-level redundant array of independent disks (RAID) architecture to increase data storage system performance and/or redundancy of data. In one embodiment, the RAID architecture includes, at the lowest or n-th layer, a plurality of nodes or storage devices implementing striped, mirrored, and/or other RAID algorithm, and assigned a system identification or LUN (logical unit number). Each LUN is part of a larger data storage system that may employ one or more other RAID organizations such as a RAID 4 or RAID 5.

### CROSS-REFERENCES TO RELATED APPLICATIONS

This non-provisional application claims priority from Provisional Patent Application Serial Nos. 60/424,130 and 60/424,348, filed Nov. 6, 2002, the contents of which are incorporated herein by reference. This non-provisional application is being filed concurrently with U.S. pat. application Ser. No. ______, entitled “______,” the contents of which are incorporated herein by reference.

### BACKGROUND OF THE INVENTION

1. Field of the Invention

The invention relates generally to redundant array of independent disks (RAID) architectures, and more specifically, to a multiple level RAID architecture.

2. Background Information

In today's data storage technology, there are several configurations for redundant array of independent disk (RAID) arrays. Beyond RAID 0/1, which is a simple stripe or mirror configuration, more redundant and complex data storage systems are available. These systems include RAID 4/5 and others as outlined in “A Case for Redundant Arrays of Inexpensive Disks,” David A. Patterson (1987) and “Raidbook, 6^{th} Edition: A Storage System Technology Handbook” Paul Massiglia (1999). RAID 4/5 systems incorporate a parity protection system, whereby any one component of the system can have its data reconstructed in the case of a storage device failure, as long as all the other components of the system are in proper working order. This is done by reading the parity information from the other storage device(s), and calculating the missing component. Typically, in this type of configuration, the information contained in the data system is distributed to the components evenly in a RAID 0 stripe configuration. Distributing the information evenly among the components allows for faster retrieval, because no one component contains all the information requested, which could slow down the system.

FIG. 1 illustrates a conventional RAID architecture used in network storage applications. The architecture includes a host and/or RAID controller 100 that reads and writes data to the underlying storage devices 120 through a communication medium 110. The host and/or RAID controller typically implement a RAID 4/5 or parity scheme that is written to the disks. This allows for some redundancy if there is a storage device failure. In addition, a RAID 0 stripe can be written to the storage devices at the same time. This stripe allows for the data to be evenly written to the devices 120 in an attempt to maximize overall system performance. FIG. 2 shows the logical assignment of information for the conventional RAID architecture of FIG. 1. Referring to FIG. 2, the data is broken down by the RAID controller into equal sizes, parity information is calculated, and the data is then written to the storage devices. Retrieving the data from storage devices is handled by reversing this process.

### BRIEF DESCRIPTION OF THE DRAWINGS

FIG. 1 illustrates a block diagram of a conventional RAID architecture.

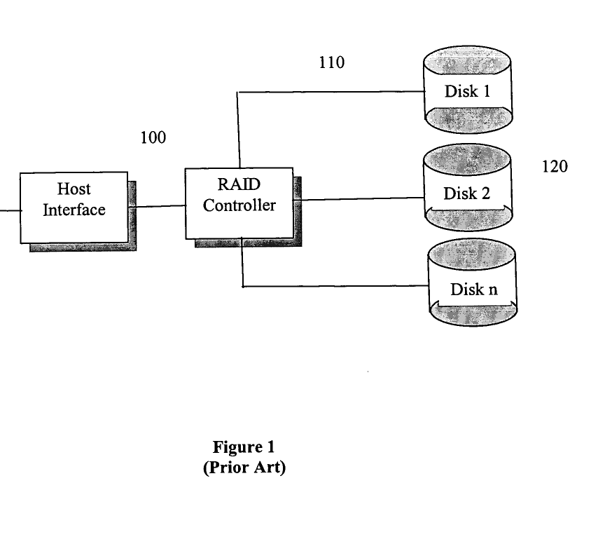

FIG. 2 illustrates the flow of data in the RAID architecture of FIG. 1.

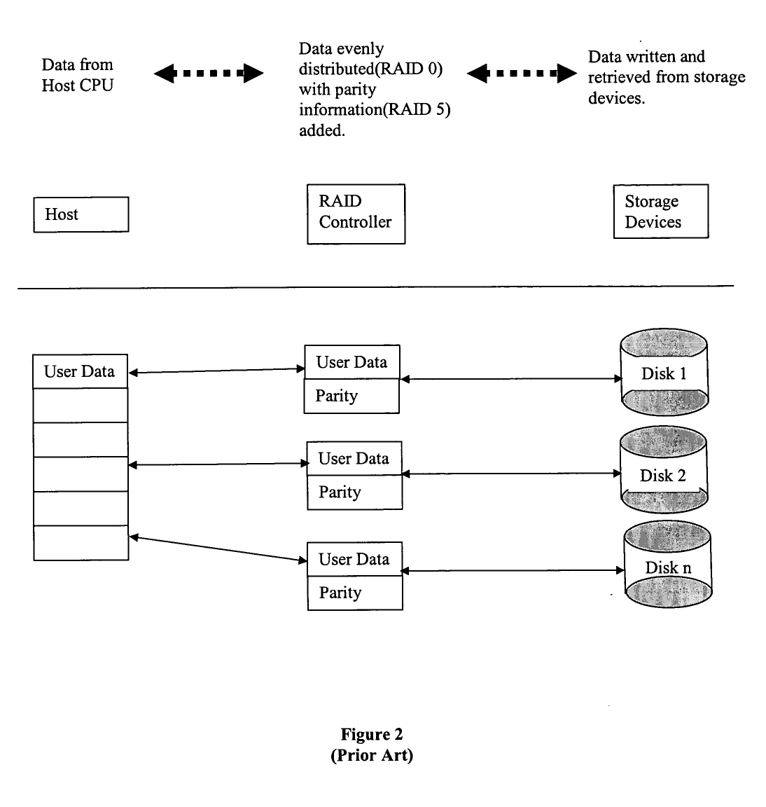

FIG. 3 illustrates a block diagram of a RAID architecture, according to one embodiment of the present disclosure.

FIG. 4 illustrates the flow of data in the exemplary RAID architecture of FIG. 3.

FIG. 5 illustrates a block diagram of a RAID architecture, according to another embodiment of the present disclosure.

FIG. 6 shows a block diagram of a RAID controller, according to one embodiment of the present disclosure.

### DETAILED DESCRIPTION

Disclosed herein are embodiments of a multi-level (or multi-stage) redundant array of independent disks (RAID) architecture, including a primary RAID controller at a first RAID level and one or more RAID controllers in at least a secondary RAID level. This implementation of a multi-level RAID architecture allows for distribution of data to provide a balanced workload and an overall increase in system performance.

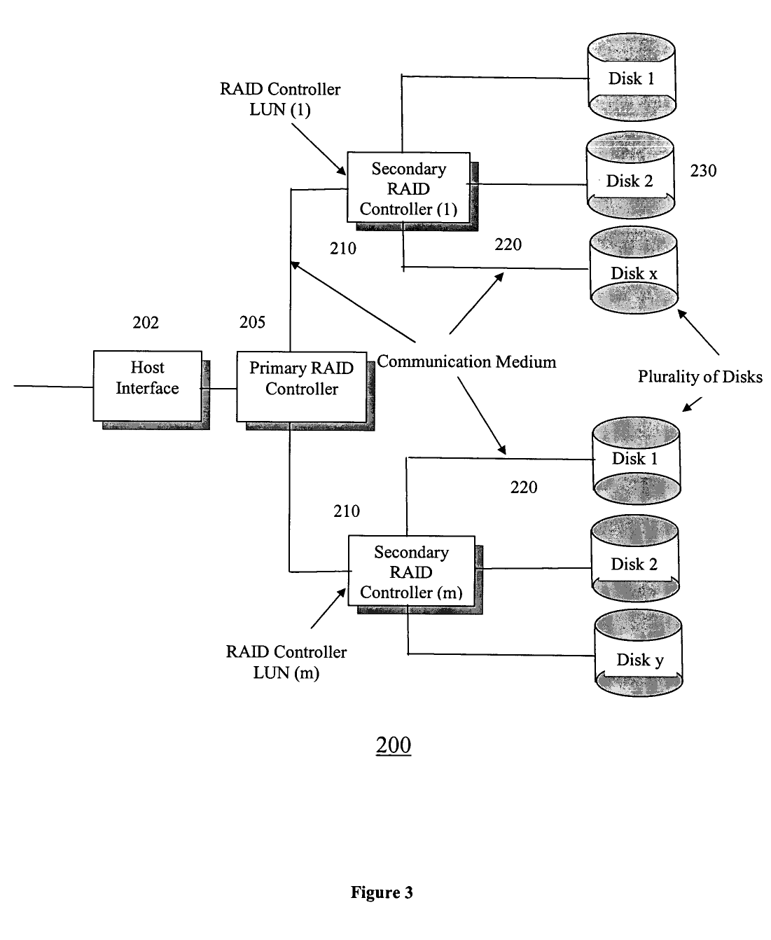

FIG. 3 illustrates a block diagram of a RAID architecture 200, according to one embodiment of the present disclosure. Referring to FIG. 3, the RAID architecture 200 includes a primary RAID controller 205 at a first RAID level (or stage) and “m” secondary RAID controllers 210 (nodes) at a secondary RAID level (or stage), where “m” is a positive whole number greater than one. The RAID architecture 200 is typically implemented in conjunction with a computer system (not shown) where the RAID controller 205 communicates with (by writing data to and reading data from the storage disks 230) a central processing unit or other component(s) of the computer system via the host interface 202. For example, the host interface 202 may comprise a “plug-in” card that is inserted into a backplane of a computer system (e.g., server), and the Primary RAID Controller 205 may communicate with this host interface card via a cable. By way of another example, the Primary RAID Controller 205 may be implemented on the “plug-in” card or on a motherboard of the computer system, and is coupled to the Secondary RAID Controllers 210 via a communication medium (e.g., cable).

In one embodiment, the primary RAID controller 205 assigns each lower level node with an identification or logical unit number (LUN), which may occur during an initialization process. When a data stream is received from the host interface 202, the primary RAID controller 205 distributes the data among the nodes, the organization of which is dependent on the design (e.g., RAID 5 and RAID 0). When commanded by the host interface 202, the primary RAID controller 205 retrieves blocks of data from the nodes and assembles the blocks in a data stream.

In one exemplary embodiment, this RAID architecture can implement a RAID 4/5 at the primary RAID controller 205 and a RAID 0 at the secondary RAID controllers 210. In this embodiment, the primary RAID controller 205 writes data to and reads data from the secondary RAID controllers 210, calculating both parity and striping the data to maximize performance. The data received by each secondary RAID controllers 210 is then re-distributed to the lower level nodes. In the exemplary embodiment above, the data received by each secondary RAID controller 210 is written in a RAID 0 stripe to the lower level nodes, which in this embodiment are disk drives 230. It is to be appreciated that each lower level node may include a plurality of storage devices and that one node may include a different number of storage devices than another node. For instance, in the architecture of FIG. 3, secondary RAID controller 210, labeled as “(1)” is coupled to “x” storage devices, while secondary RAID controller 210, labeled as “(m)” is coupled to “y” storage devices (where “x” and “y” are positive whole numbers greater than one and may be different). Each secondary RAID controller 210 can assign an identification or LUNs to the lower level nodes. Thus, the primary RAID controller 205 performs a RAID 0(type) stripe along with a RAID 4/5 parity protection. The secondary level RAID Controllers each performs a RAID 0 stripe to the lowest level disks.

The communication medium coupling the nodes (higher and lower level nodes) may include cables, printed circuit boards, any other means of transferring digital data, and combinations thereof. Note also that while the embodiment of FIG. 3 utilizes disk drives to store data, any other type of storage devices may be used, in addition to or in lieu of the disk drives 230, including, but not limited to, rigid disk drives, media drives (e.g., removable), optical drives, solid state semiconductor storage, etc. and combinations thereof. Each RAID controller (primary and/or secondary) may implement the RAID level calculations/operations in hardware (e.g., using a hardware XOR engine with or without instruction sets) or software (e.g., using a central processing unit executing dedicated software to calculate, for example, RAID 4/5 parity and generate the RAID stripe).

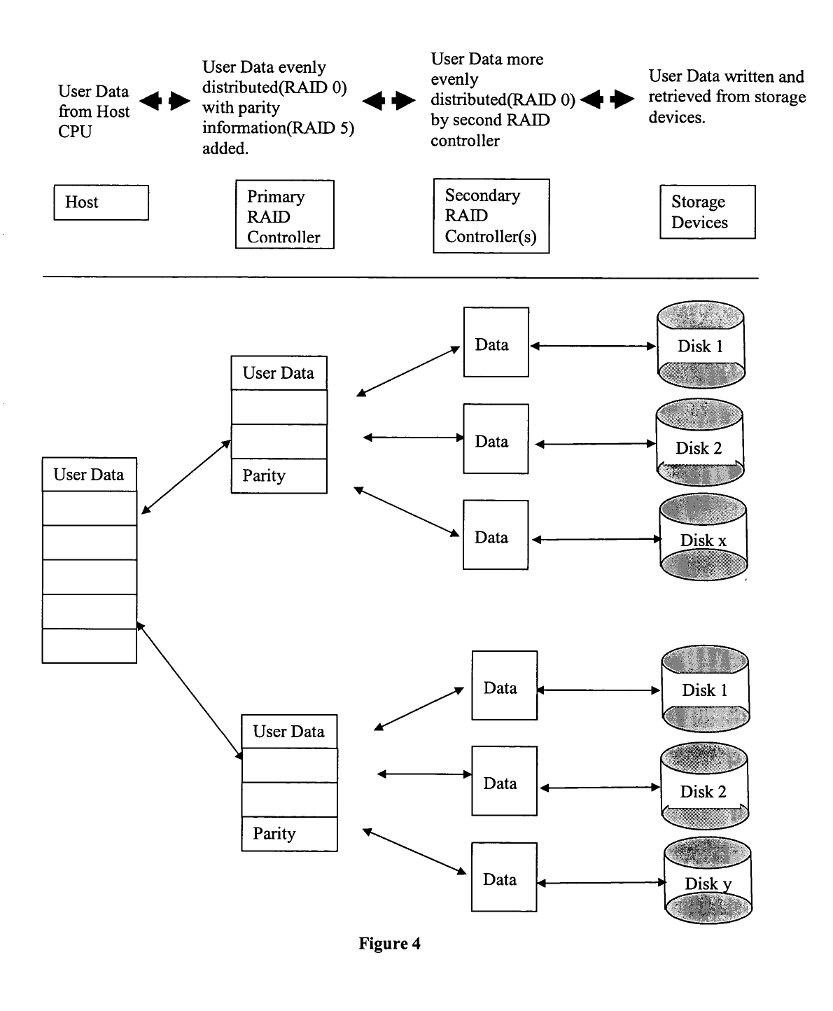

FIG. 4 illustrates the functional flow of data in the exemplary RAID architecture of FIG. 3. As can be seen, the primary RAID controller 205 evenly distributed the data among the lower nodes (secondary RAID controllers) with parity information added. Each secondary RAID Controller 210 receives the data, with parity calculated, and then again evenly redistributed the block of data among the lower nodes (storage disks).

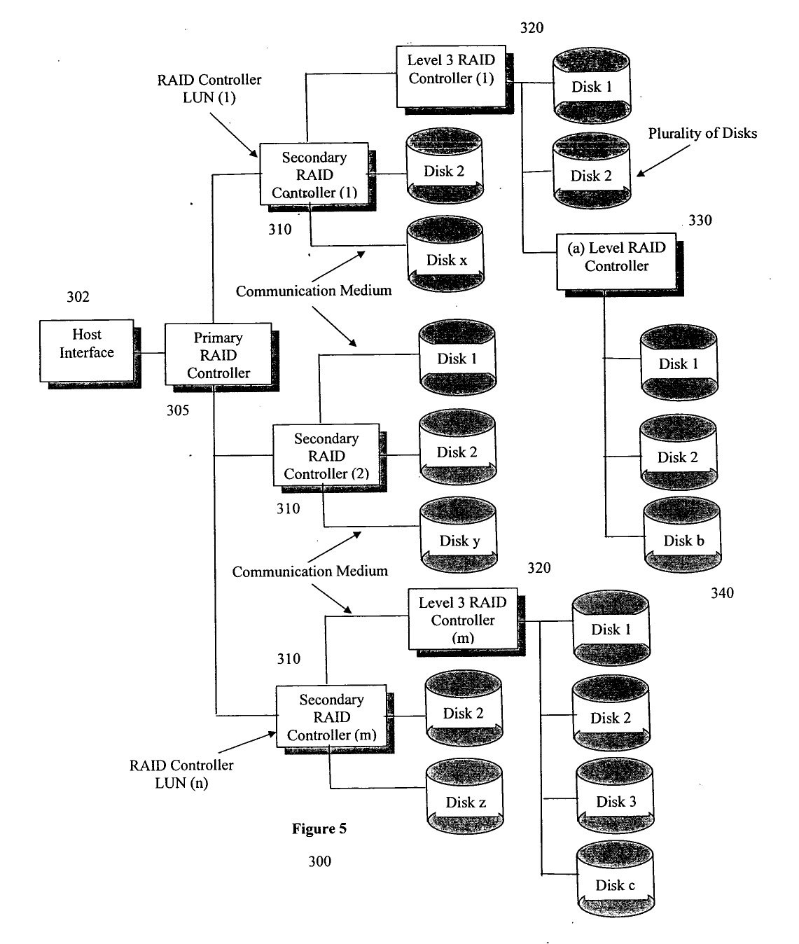

FIG. 5 illustrates is a block diagram of a RAID architecture, according to another embodiment of the present disclosure. This exemplary embodiment shows the versatility of the teachings of the present disclosure in which many RAID levels, each cascaded into the next, may be used. Many different configurations are possible using a different RAID 0 to 5 architecture, or combinations of RAID architectures, implemented at different levels.

As can be seen, this flexible architecture includes “a” RAID levels. Any one of the levels could perform RAID 0 to RAID 5, or any combination thereof. Moreover, a node for any RAID controller can be a storage device or another RAID controller.

The higher level RAID controller can assign an identification or LUN to the lower level nodes.

Referring to FIG. 5, this architecture 300 includes a primary RAID Controller 305 and “m” secondary RAID controllers 310 (where “m” is a positive whole number greater than one). The primary RAID controller 305 could implement a RAID 4/5 parity and RAID 0 stripe to the secondary RAID controllers 310. The secondary RAID controllers 310 could then implement a RAID 0 stripe or other RAID implementation to the next lower level. In this embodiment, at the fourth level one of the nodes is a RAID Controller while the other nodes are storage devices. This fourth level RAID Controller could implement a RAID 0 stripe or other RAID implementation to the storage devices at the fifth level 340.

A mirrored implementation may similarly be implemented, where the primary level is a RAID 4/5 or other configuration, and the secondary level is RAID 1 mirror layer, including a group of storage devices that are identical mirrors of each other. In this configuration, each device would be redundant of the other and could take its place were any device to fail. It is to be appreciated that theoretically any RAID configuration can be employed at any level.

Many additional levels of RAID 0 striping or RAID 1 mirroring combinations are possible to allow for an even more balanced workload and/or greater system redundancy. It should be noted that at some point the latency or system overhead to manage additional levels of RAID controllers and/or storage devices, may slow down the system performance.

At each level or layer of the system, it would be possible to have a minimum of two nodes connected to the higher level RAID controller in a RAID 0 configuration. For example, the secondary RAID Controller “1” is coupled to “x” nodes where one of the nodes is a lower level RAID Controller, while the secondary RAID Controller “2” is coupled to “y” nodes where each node is a storage device (“x” and “y” may be different values).

There are several general guidelines that may be followed to assist in designing a multi-level RAID architecture. First, any number of layers is possible. However, performance can suffer if too many layers are connected due to latency at each layer or the command overhead to calculate and reconstruct the data. Second, a minimum of two storage devices are needed to form a new layer below a higher layer in a RAID 0 configuration. This is necessary because at least two storage devices are required to form a RAID 0 stripe. In a RAID 1 configuration, one storage device can mirror the previous level's data. There is no maximum number of storage devices that can be configured to form a stripe, but again performance may be limited with too many components. Third, all components of the previous layer do not need additional components or stripes below them. This again can limit performance or redundancy, because the previous layer component without a subsequent RAID 0/1 stripe can be the slowest or most vulnerable part of the system. Finally at every level, each RAID controller may assign unique identification or LUNs to the components or nodes it controls. It in turn may be assigned a unique identification or LUN by the RAID controller in the layer above it.

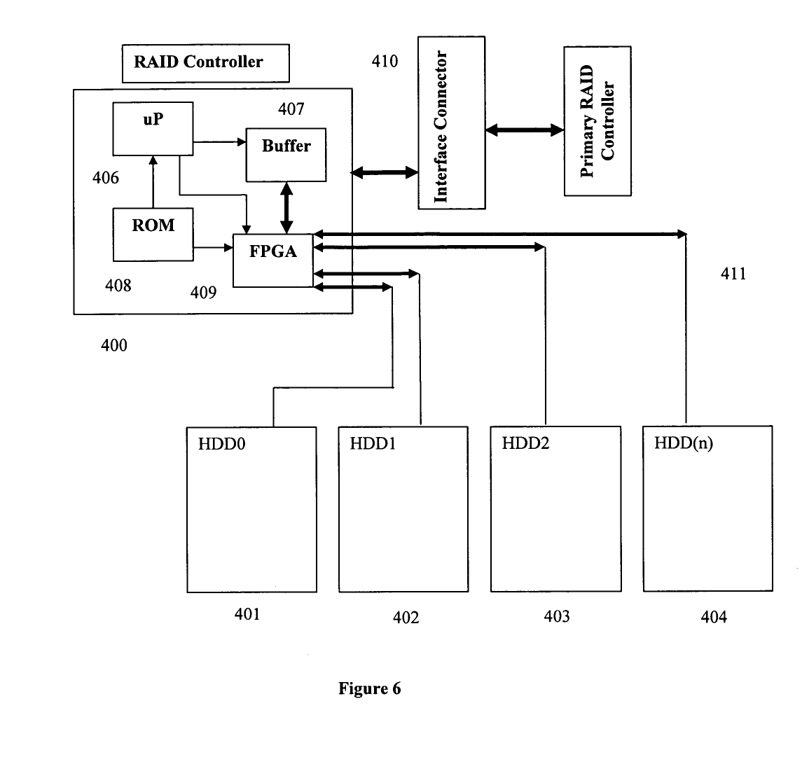

FIG. 6 shows a block diagram of a RAID controller, according to one embodiment of the present disclosure. This embodiment shows how to connect the plurality of storage devices into a RAID array, before connecting this into the higher level or primary RAID architecture through the communication medium.

Referring to FIG. 6, the RAID controller 400 includes a central processing unit 406 (e.g., a microprocessor, microcontroller, ASIC, or the like), buffer RAM 407, read-only memory 408, and field programmable gate array or ASIC semiconductor device 409. The buffer RAM 407 may be used to sequence the data entering and exiting the RAID Controller 400. The read-only memory 408 may be programmable read only memory or other non-volatile memory that contains the instruction set for how to handle the data being sequenced through the RAID Controller 400. The field programmable gate array (FPGA) 409 or ASIC that interfaces with a plurality of storage devices 401-404 contains the logic for how to break down and reassemble the data being read from and written to each component of the new layer. The FPGA would also contain the algorithms to perform parity calculations for use in RAID 4/5 applications, and assignment of identification to the storage devices and RAID controllers at the lower levels.

Data to be written to storage disks 401-404 would move from the primary RAID Controller (from the host), through the Interface connector 410, and into the buffer RAM 407 of RAID Controller 400. Depending on the configuration setting as defined by, for example, the code in ROM 408, the RAID Controller would determine the RAID algorithm to use to distribute the data. In a RAID 5 configuration, for instance, the ROM would instruct the FPGA to disassemble the data into a RAID 0 stripe, and calculate parity for the data stripe, RAID 4/5. The data would then move through the RAM and FPGA, where the stripe and parity is calculated and attached to the data, before being sent to the storage devices 401-404. In the case of reading from the storage devices, the process would operate in reverse. Given that the RAM 407, ROM 408, and FPGA 409 are manipulating the data to and from the storage devices, it would be possible to manage the data in any desired form required by/for the storage devices, RAID controller, and host bus adaptor, such as SCSI, ATA, FC, SATA, SAS or other command interfaces. For example, data may be transmitted between the RAID controllers and storage devices by means of an SCA or other type Interface Connector 410. It is to be appreciated that the calculations/operations of the FPGA can be done in software using a software algorithm (e.g., stored on ROM) executed by a processor such as CPU 406 or other dedicated processor.

In this embodiment, using the above components would allow for each secondary RAID controller to appear to be one large volume or storage device. This would allow for the data system to address each component at each level as a distinct identification or LUN.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus, comprising:
a plurality of storage devices divided into a first set of one or more storage devices and a second set of one or more storage devices;
a first RAID controller; and
first and second secondary RAID controllers coupled to the first RAID controller, said first secondary RAID controller coupled to the first set of storage devices and said second secondary RAID controller coupled to the second set of storage devices.

2. The apparatus of claim 1 wherein said first RAID controller is a primary RAID controller.

3. The apparatus of claim 2 wherein said primary RAID controller configured to operate on data according to a first RAID type and at least one secondary RAID controller configured to operate on data according to a second RAID type.

4. The apparatus of claim 3 wherein said first RAID type includes one of a RAID 0, RAID 1, RAID 2, RAID 3, RAID 4, and RAID 5, and said second RAID type includes one of a RAID 0, RAID 1, RAID 2, RAID 3, RAID 4, and RAID 5.

5. The apparatus of claim 1 further comprising:
a tertiary RAID controller coupled to a third set of one or more storage devices, and one of the first and second secondary RAID controllers.

6. The apparatus of claim 1 wherein said plurality of storage devices include one or more of the following: a hard disk drive, optical drive, and solid state storage device.

7. The apparatus of claim 1 wherein each of said first and second secondary RAID controllers is assigned a unique identifier.

8. The apparatus of claim 1 wherein one or more of said primary RAID controller and said secondary RAID controllers comprises:
a central processing unit;
volatile memory coupled to said central processing unit for buffering and operating on data flowing through said RAID controller; and
non-volatile memory containing instructions, said instructions when executed by said central processing unit to control operation of said RAID controller.

9. The apparatus of claim 8 wherein said RAID controller further comprises:
a circuit coupled to said central processing unit to operate on data according to one or more RAID types.

10. A data storage system, comprising:
a first RAID controller to receive a data stream and perform at least a first RAID type on said data stream to provide first and second sub-data streams; and
first and second secondary RAID controllers coupled to said first RAID controller, said first and second secondary RAID controllers to receive said respective first and second sub-data streams and each to perform respective second and third RAID types on said first and second sub-data streams.

11. The data storage system of claim 10 further comprising:
a first set of one or more storage devices coupled to said first secondary RAID controller; and
a second set of one or more storage devices coupled to said second secondary RAID controller;
said first secondary RAID controller to distribute smaller first streams of data to said respective first set of one or more storage devices, and said second secondary RAID controller to distribute smaller second streams of data to said respective second set of one or more storage devices.

12. The data storage system of claim 10 wherein one or more of said first, second, and third RAID types including one or more of the following: a RAID 0, RAID 1, RAID 2, RAID 3, RAID 4, and RAID 5.

13. The data storage system of claim 10 wherein each of said first and second secondary RAID controllers is assigned a unique identifier.

14. The data storage system of claim 11 wherein said first and second sets of storage devices include one or more of the following: a hard disk drive, optical drive, and solid state storage device.

15. The data storage system of claim 11 wherein said primary RAID controller communicates with a host for writing data to and reading data from said first and second sets of storage devices.

16. A method of storing data in a RAID architecture, comprising:
receiving a data stream from a host;
operating on said data stream according to a first RAID type to provide first and second sub-data streams, and distributing said first and second sub-data streams;
receiving said first sub-data stream, operating on said first sub-data stream according to a second RAID type to provide a plurality of first data units, and distributing said plurality of first data units; and
receiving said second sub-data stream, operating on said second sub-data stream according to a third RAID type to provide a plurality of second data units, and distributing said plurality of second data units.

17. The method of claim 16 further, comprising:
storing said plurality of said first data units on a respective first plurality of storage devices; and
storing said plurality of said second data units on a respective second plurality of storage devices.

18. The method of claim 16 wherein operating on said data stream according to said first RAID type comprises operating on said data stream according to one or more of a RAID 0 type, RAID 1 type, RAID 2 type, RAID 3 type, RAID 4 type, and RAID 5 type, wherein operating on said first sub-data stream according to said second RAID type comprises operating on said first sub-data stream according to one or more of a RAID 0 type, RAID 1 type, RAID 2 type, RAID 3 type, RAID 4 type, and RAID 5 type, and wherein operating on said second sub-data stream according to said third RAID type comprises operating on said second sub-data stream according to one or more of a RAID 0 type, RAID 1 type, RAID 2 type, RAID 3 type, RAID 4 type, and RAID 5 type.
